(19) United States
(12) Patent Application Publication
(10) Pub. No.: US 2026/0340369 A1
(43) Pub. Date: Oct. 29, 2026

(54) METHODS AND APPARATUS FOR CONVERTING PRE-TRAINED MODEL DATA FORMAT, WITHOUT RETRAINING

(71) Applicant: QUALCOMM Incorporated, San Diego, CA (US)

(72) Inventors: Anuj GUPTA, Bangalore (IN); Ilango RAJAGOPAL, Coimbatore (IN)

(21) Appl. No.: 19/490,289

(22) PCT Filed: Jun. 14, 2024
(86) PCT No.: PCT/US2024/034211

§ 371 Date: Dec. 4, 2025

(30) Foreign Application Priority Data
Jul. 14, 2023 (IN) 202341047622
Oct. 11, 2023 (WO) PCT/US2023/034975
Feb. 14, 2024 (IN) 202441010214

(51) Int. Cl. G06N 3/0495

(52) U.S. Cl. CPC G06N 3/0495

(57) ABSTRACT

A processor-implemented method for converting pre-trained models from a first floating point format to a second floating point format includes receiving an artificial neural network (ANN) model as an input. The ANN model is trained to operate on values in the first floating point format. A layer of the ANN model in which to apply a scaling parameter is selected based on a layer type and a topology of the ANN model. A maximum intermediate value is determined according to a distribution of weights in the selected layer of the ANN model. The scaling parameter is computed based on a ratio of the maximum intermediate value and a maximum representable value. The scaling parameter is applied to weights of the selected layer of the ANN model.

### CROSS-REFERENCE TO RELATED APPLICATIONS

The present application claims the benefit of Indian Patent Application number 202441010214, filed on Feb. 14, 2024, and titled “METHODS AND APPARATUS FOR CONVERTING PRE-TRAINED MODEL DATA FORMAT WITHOUT RETRAINING,” and PCT Application No. PCT/US2023/034975, filed Oct. 11, 2023, and titled “METHODS AND APPARATUS FOR CONVERTING PRE-TRAINED MODEL DATA FORMAT, WITHOUT RETRAINING,” which claims the benefit of Indian Patent Application number 202341047622, filed on Jul. 14, 2023, and titled “CONVERTING PRE-TRAINED MODEL DATA FORMAT, WITHOUT RETRAINING,” the disclosures of which are expressly incorporated by reference in their entireties.

### FIELD OF THE DISCLOSURE

Aspects of the present disclosure generally relate to data processing, and more specifically floating point data in machine learning models. Aspects relate more particularly to converting pre-trained models from operating with floating point data in a first format to operating with floating point data in a second format, without retraining the models.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

The use of floating point values allows for calculations in many neural network applications to be sufficiently precise. This is particularly so for applications such as autonomous driving. Representing floating point values in computing is very challenging given device size and memory constraints. Floating point values are generally represented using scientific or engineering notation. Given a bit format (e.g., 16-bit or 32-bit), the number of bits may be divided to represent different portions of the floating point value in scientific notation. For example, one bit may represent a sign of the floating point value. One set of bits may represent the mantissa (also referred to as significant bits) and another set of bits may represent the exponent.

In computing, half-precision is a format for representing floating point values. Half-precision may be referred to as a floating point bit format that uses sixteen bits in computer memory. However, half-precision format may provide lower precision. The industry standard for half-precision formats is the Institute for Electrical and Electronic Engineers (IEEE) sixteen-bit floating point (FP16) format. The IEEE FP16 format consumes less memory and enables faster computation than higher precision formats, such as single precision (thirty-two bit format) or double precision (sixty-four bit format), but provides lower precision and a smaller range.

To provide greater precision in neural network applications, some conventional approaches have attempted to use non-standard FP16 (e.g., a format other than IEEE FP16) formats. However, when a pre-trained model is designed with such non-standard FP16 formats, it may be challenging and, in some cases, not possible to utilize inference accelerators, which are often designed to support standard data formats.

### SUMMARY

The present disclosure is set forth in the independent claims, respectively. Some aspects of the disclosure are described in the dependent claims.

In some aspects of the present disclosure, a processor-implemented method includes receiving an artificial neural network (ANN) model as an input. The ANN model is trained to operate on values in a first floating point format having a bit length. The processor-implemented method also includes selecting a layer of the ANN model in which to apply a scaling parameter based on a layer type and a topology of the ANN model. The processor-implemented method further includes determining a maximum intermediate value according to a distribution of weights in the selected layer. The processor-implemented method additionally includes computing the scaling parameter based on a ratio of the maximum intermediate value and a maximum representable value. Further still, the processor-implemented method includes applying the scaling parameter to weights of the selected layer of the ANN model.

Various aspects of the present disclosure are directed to an apparatus including means for receiving an artificial neural network (ANN) model as an input. The ANN model is trained to operate on values in a first floating point format having a bit length. The apparatus also includes means for selecting a layer of the ANN model in which to apply a scaling parameter based on a layer type and a topology of the ANN model. The apparatus further includes means for determining a maximum intermediate value according to a distribution of weights in the selected layer. The apparatus additionally includes means for computing the scaling parameter based on a ratio of the maximum intermediate value and a maximum representable value. Furthermore, the apparatus includes means for applying the scaling parameter to weights of the selected layer of the ANN model.

In some aspects of the present disclosure, a non-transitory computer-readable medium with program code recorded thereon is disclosed. The program code is executed by a processor and includes program code to receive an artificial neural network (ANN) model as an input. The ANN model is trained to operate on values in a first floating point format having a bit length. The program code also includes program code to select a layer of the ANN model in which to apply a scaling parameter based on a layer type and a topology of the ANN model. The program code further includes program code to determine a maximum intermediate value according to a distribution of weights in the selected layer. The program code additionally includes program code to computing the scaling parameter based on a ratio of the maximum intermediate value and a maximum representable value. The program code also includes program code to applying the scaling parameter to the weights of the selected layer of the ANN model.

Various aspects of the present disclosure are directed to an apparatus having at least one memory and one or more processors coupled to the at least one memory. The processor(s) is configured to receive an artificial neural network (ANN) model as an input. The ANN model is trained to operate on values in a first floating point format having a bit length. The processor(s) is also configured to select a layer of the ANN model in which to apply a scaling parameter based on a layer type and a topology of the ANN model. The processor(s) is additionally configured to determine a maximum intermediate value according to a distribution of weights in the selected layer. The processor(s) is further configured to compute the scaling parameter based on a ratio of the maximum intermediate value and a maximum representable value. Furthermore, the processor(s) is configured to apply the scaling parameter to the weights of the selected layer of the ANN model.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a diagram illustrating example pseudocode for determining a scaling factor, in accordance with various aspects of the present disclosure.

FIGS. 6A and 6B are block diagrams illustrating an example artificial neural network (ANN) model and a corresponding conversion from sixteen-bit brain floating point (bfloat16) format to Institute for Electrical and Electronic Engineers (IEEE) sixteen-bit floating point (FP16) format using a scaling factor, in accordance with various aspects of the present disclosure.

FIG. 7 is a flow diagram illustrating an example processor-implemented method for converting pre-trained models from bfloat16 format to FP16 format using a varying scaling factor, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The brain floating point format is a custom 16-bit floating point format (may be referred to as bfloat16 or BF16). The bfloat16 format includes one sign bit, eight exponent bits, and seven mantissa bits. This is different from the industry-standard Institute for Electrical and Electronic Engineers (IEEE) 16-bit floating point (FP16) format, which was not designed with deep learning applications in mind. The IEEE FP16 format includes one sign bit, five exponent bits, and 10 mantissa bits.

Bfloat16 is a truncated version of IEEE 32-bit single-precision floating-point, developed by GOOGLE BRAIN, by reducing the fraction part (e.g., the mantissa) to seven bits but keeping the exponent at eight bits. Bfloat16 aims to reduce training time and overall size of the model. However, because of the smaller number of bits in the fraction part (e.g., the mantissa), the models tend to use exponent bits to express the weights. As a result, small changes in exponent bits may cause the absolute values of the weights to be too high. That is, models with higher exponents and thus, higher values, may not fit in a hardware (e.g., memory) that supports IEEE FP16, producing a data overflow, which may reduce model accuracy. Moreover, even if the weights are in the range of IEEE FP16, the intermediate activations may go out of IEEE FP16 range, again due to higher values of weights.

Some conventional approaches attempt to scale down all weights with pre-defined hardcoded values to fit in IEEE FP16 range. However, such approaches utilize empirical selection of a scaling factor until the solution works and may fail for different inputs that were not seen or may fail for other datasets. Additionally, these conventional approaches may only work on a few architectures and may have difficulty handling non-linearities other than rectifier linear units.

Accordingly, to address these and other challenges, aspects of the present disclosure are directed to converting pre-trained models from the bfloat16 format to the IEEE FP16 format. For dense layers having an activation that is not scale-invariant or a non-zero bias, weight scaling may be applied for architectures including a pre-activation or by applying the scaling factor to the non-zero bias.

Particular aspects of the subject matter described in this disclosure can be implemented to realize one or more of the following potential advantages. In some examples, the described techniques may beneficially convert pre-trained models from the bfloat16 format to the IEEE FP16 format without retraining. Accordingly, aspects of the present disclosure may avoid the burdensome and time-consuming task of retraining an artificial neural network (ANN) model. Additionally, the described techniques may produce a converted model that preserves the accuracy (e.g., increased precision) of the original ANN model while enabling the use of conventional accelerators. Moreover, because the disclosed techniques enable ANN models to operate with a smaller range of values, inference time may also be reduced.

Furthermore, text-based video editing may enhance camera features. For example, aspects of the present disclosure may enable content editing of videos captured using a camera. For example, a captured video may be edited before being shared. Additionally, user personalization may be carried out to inject personal effects into a video.

Certain aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases may represent offsets that may indicate a starting point for outputs of the ML model. An example ML model, operating on input data, may start at an initial output based on the biases and then update its output based on a combination of the input data and the weights.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values that are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

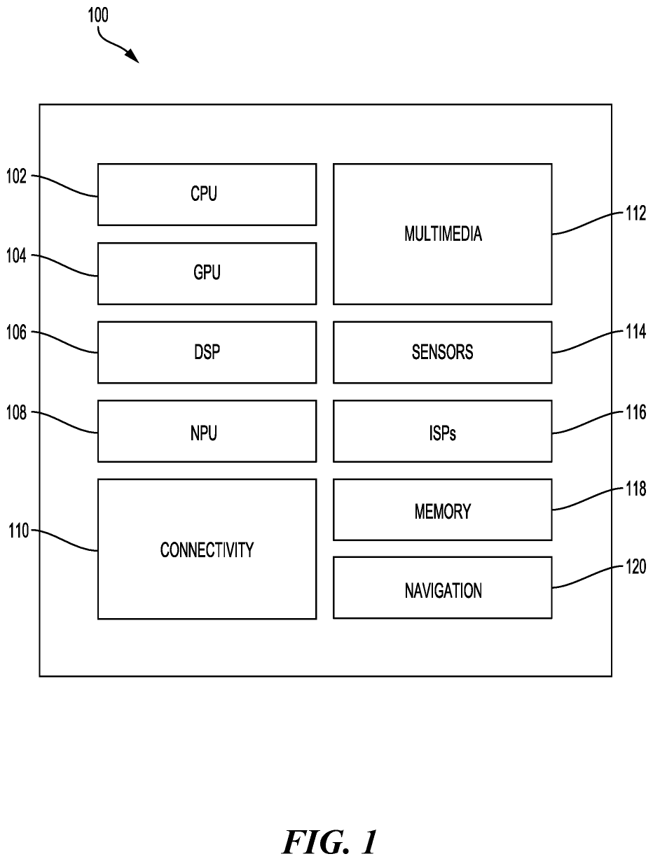

FIG. 1 illustrates an example implementation of a system-on-a-chip (SOC) 100, which may include a central processing unit (CPU) 102 or a multi-core CPU configured for converting pre-trained models from operating with floating point data in a first format to a second format, without retraining the models. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive an artificial neural network (ANN) model as an input. The ANN model is trained to operate on values in a first floating point format having a bit length. The instructions loaded into the general-purpose processor 102 may also include code to select a layer of the ANN model in which to apply a scaling parameter based on a layer type and a topology of the ANN model. The instructions loaded into the general-purpose processor 102 may further include code to determine a maximum intermediate value according to a distribution of weights in the selected layer. The instructions loaded into the general-purpose processor 102 may additionally include code to compute the scaling parameter based on a ratio of the maximum intermediate value and a maximum representable value. Furthermore, the instructions loaded into the general-purpose processor 102 may include code to applying the scaling parameter to the weights of the selected layer of the ANN model.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

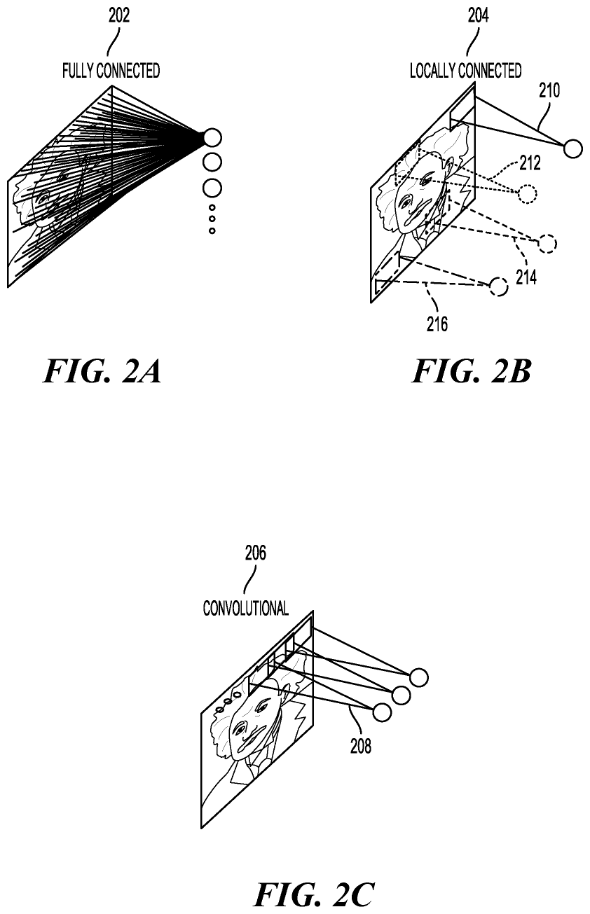

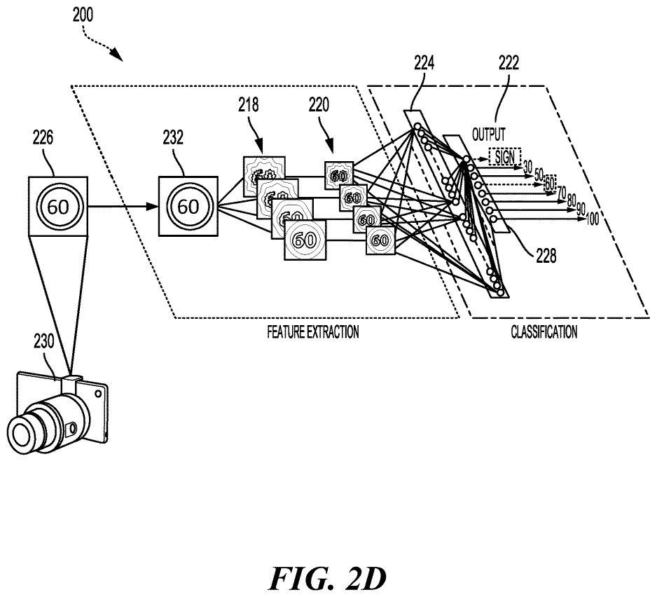

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

An optimization algorithm may be used during a training process to adjust weights and biases as needed to reduce or minimize the loss function, which should improve the performance of the model. There are a variety of optimization algorithms that may be used along with backpropagation techniques or other training techniques. Some initial examples include a gradient descent-based optimization algorithm and a stochastic gradient descent-based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max (0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

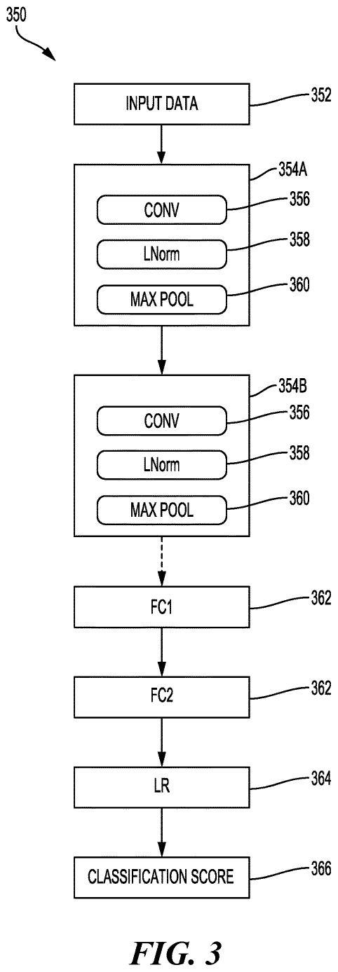

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

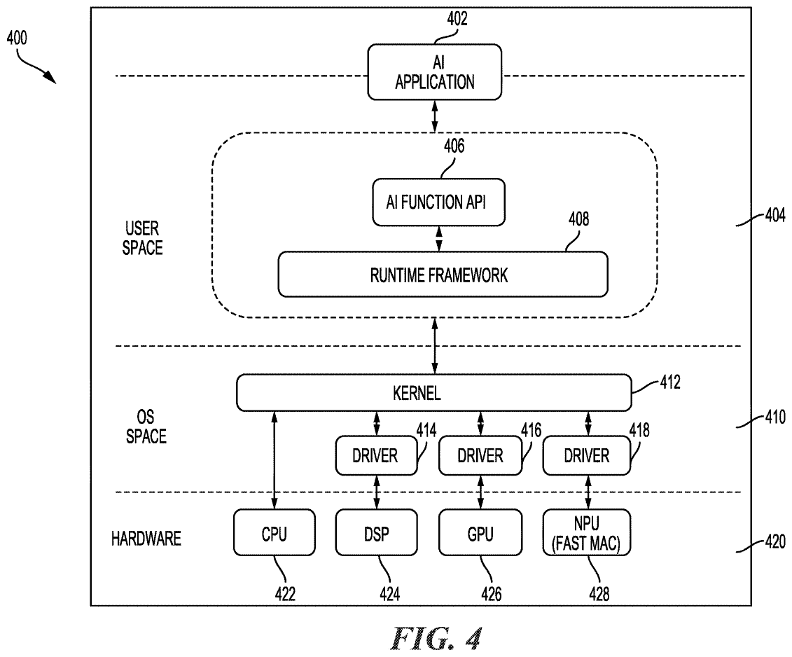

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) to support floating point format conversion for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to converting pre-trained models from operating with floating point data in a first format to operating with floating point data in a second format, without retraining the models. For example, the first format may be a bfloat16 format and the second format may be an Institute for Electrical and Electronic Engineers (IEEE) FP16 format.

In various aspects, ANN architectures and weights may be mathematically modeled to determine sensitive layers or blocks (e.g., blocks that may be more susceptible to overflow errors). For instance, a mathematical model may be applied to determine certain blocks (or layers) of an ANN that may be scaled and blocks of the ANN that may be retained without scaling. Different scaling factors may be computed for different blocks and weights. In some aspects, a worst-case analysis may be employed to further reduce overflow errors. For example, a worst range of the scaling factor may be determined without using a dataset.

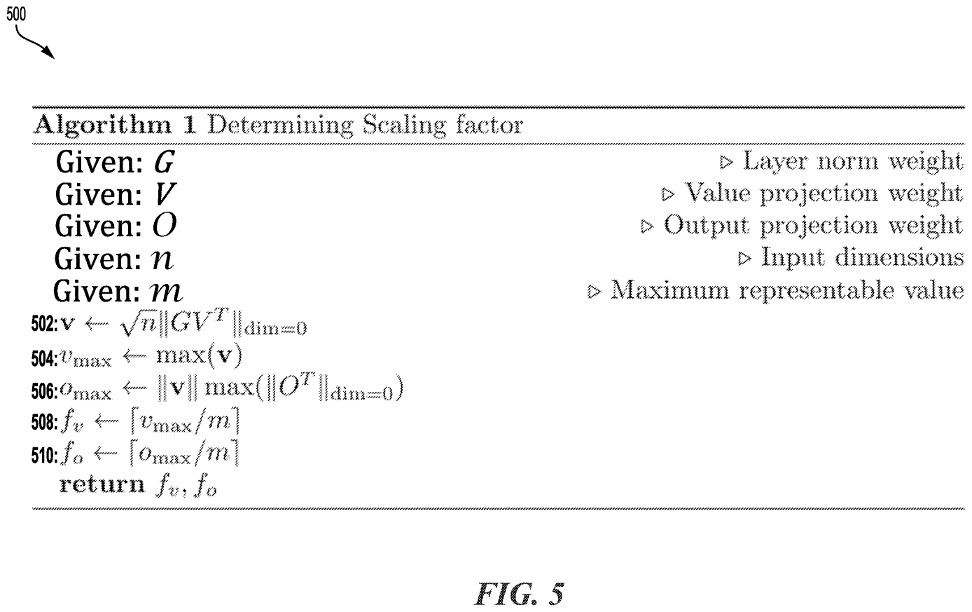

FIG. 5 is a diagram illustrating example pseudocode 500 for determining scaling factors, in accordance with aspects of the present disclosure. Referring to FIG. 5, the example pseudocode 500 may determine scaling factors for parameters (e.g., weights) in various blocks (e.g., self-attention block or cross-attention block) of an ANN model. Rather than determining a uniform scaling factor (e.g., fixed scaling factor) that is applied to multiple blocks (or layers) of the ANN, different scaling factors may be determined for different blocks (or layers) of the ANN. For instance, a different scaling factor may be applied for layers including (but not limited to) dense layers, self-attention layers or normalization layers. In some aspects, the ANN model may comprise a convolutional neural network (CNN) (e.g., the DCN 350 shown in FIG. 3), a recurrent neural network (RNN), a transformer neural network or other neural network, for example.

Given layer norm weights, value projection weights, output projection weights, dimensions of the ANN inputs and a maximum representable value (e.g., for a specific hardware device such as a hardware accelerator), the scaling factors may be determined. As shown at line 502, intermediate values v may be computed. The intermediate values v may be given by matrix multiplication of the layer norm weights G and the transpose of the value projection weights V (GV^{T}) multiplied by the square root of the input dimensions (\sqrt{n}). At line 504, a maximum of the intermediate values (vₘₐₓ) may be determined. At line 506, a maximum output value (oₘₐₓ) may then be determined. The maximum output value (oₘₐₓ) may be calculated by multiplying the intermediate value v by the transpose of the maximum of the output projection weights O. At line 508, a scaling factor (fᵥ) for the value projection weights may be determined by dividing the maximum intermediate value vₘₐₓ by the maximum representable value m. For instance, for IEEE FP16, the maximum representable value may be 65004. Additionally, at line 510, a scaling factor (fₒ) for the output projection weights may be determined by dividing the maximum output value oₘₐₓ by the maximum representable value m. Because the maximum output value may differ for each block, the scaling factor may likewise be different. Accordingly, aspects of the present disclosure may determine scaling factors based on the distribution of weights in a block rather than based on the dataset (e.g., validation dataset). That is, the scaling factors (fᵥ, fₒ) are not based on the particular values of the input but rather, the weights of the various layers (e.g., layer norm weights, value projection weights, output project weights).

In accordance with aspects of the present disclosure, weight scaling may be applied such that the ANN model weights assume lower absolute values, while still maintaining the mathematical equivalence across blocks in the ANN model. The lower absolute values of weights may reduce overflows and, in some aspects, may make the intermediate activations (e.g., an intermediate layer output) immune against IEEE FP16 overflow.

As described, different scaling strategies may be employed for different architectures. Scaling factors for the different layers of the ANN model may be mathematically deduced using the weights of the respective layers. That is, different layers of the ANN model may be adapted in different ways based on the mathematical properties. For instance, for a dense layer (e.g., fully connected layer) with a rectifier linear unit (ReLU) activation or without any activation, weights may be scaled as follows:

$$α \cdot ReLU ( \frac{W}{α} x ) = ReLU ( Wx ) \qquad ( 1 )$$

$$α \frac{W}{α} x = Wx \qquad ( 2 )$$

$$α \cdot ReLU ( \frac{W}{α} x + \frac{b}{α} ) = ReLU ( Wx + b ) , \qquad ( 3 )$$

where W is a weight, x is an input, b is a bias, and α is a scaling factor.

If the dense layer does not have a bias, the scaling factor may be applied as shown in Equation 1. On the other hand, if the dense layer has a bias, the scaling factor may be applied as shown in Equation 3. That is, the bias may be scaled along with the weights, so that the output is also scaled in a similar manner. In some aspects, Equation 3 may be applied only when the activation function is linear on both sides of zero (negative and positive).

Although the activation in Equation 3 is the ReLU function, the present disclosure is not so limited. Rather, the scaling factor may be applied even if ReLU is not the activation function in the ANN model, if the nonlinear function is applied with “pre-activation.” That is, the scaling factor may be applied where a non-linear activation is included before (e.g., precedes) a linear layer or convolutional neural network (CNN) layer. For example, in a stable diffusion XL (SDXL) model, the layers may be arranged in the following order: a group normalization, a sigmoid linear unit (SiLU) non-linearity, and a convolution layer. The SiLU function may be expressed as x*σ(x), where σ(x) is the logistic sigmoid function. In this example, the weights and biases of the convolution may be scaled because the next block in the SDXL model has the same order of layers. Group normalization is first applied, which may reset the scaling factor. Accordingly, the outputs for the current block may remain unchanged.

When a block (or layer) has residual connections, the scaling factor may be applied to both inputs and outputs so that the inputs and outputs are on the same scale and may be added, as shown below:

$$α \cdot ( \frac{x}{α} + ReLU ( \frac{Wx}{α} ) ) = x + ReLU ( Wx ) . \qquad ( 4 )$$

Accordingly, for layers with a residual connection, the inputs may be scaled by scaling the weights of the previous layers, or by introducing a scaling operator between the nodes.

Additionally, if the ANN model has normalization layers (e.g., layer normalization (LayerNorm) or root mean square layer normalization (RMSNorm)), the scaling of activations may be reset. That is, the scaling factor applied in a previous layer has no effect. This is because when a layer has weight scaling applied and that layer is followed by normalization layer (e.g., LayerNorm or RMSNorm), the output of the normalization layer has the same output as that of a normalization without scaling. As such, weight scaling may be applied to further layers (e.g., for residual) or re-scaling may be applied to the outputs by adapting the normalization layers, for example, as follows:

$$LayerNorm ( \frac{x}{α} ) = LayerNorm ( x ) \qquad ( 5 )$$

$$RMSNorm ( \frac{x}{α} ) = RMSNorm ( x ) . \qquad ( 6 )$$

In some aspects, a scaling operator may alternatively or additionally be employed. For example, an elementwise multiplication node/operation may be added at the point with a scaling factor as a parameter.

Scale(x,α)=α⊗x, (7)

where ⊗ denotes the tensor product.

The scale operator may, for instance, be inserted between blocks or layers of the ANN model to disentangle/re-scale the scaling currently maintained in the layer activations. For example, when using RMSNorm along with residual connections, the scaling operator may re-scale the inputs.

Additional analysis of the ANN model may be performed to determine the scaling factor because each block has different weights. Using a single large scaling factor may reduce the accuracy of the ANN model due to inability of the accelerator to represent the scaled values, for example.

In various aspects, determining scaling factors may involve accessing the extreme values (e.g., minimum (min) and maximum (max)) of inputs, which are outputs of a previous layer. Accordingly, analysis of the extreme values of all preceding layers may be performed.

In the described analysis, when the models have normalization layers (e.g., LayerNorm or RMSNorm), only the extreme values of the normalized tensors (e.g., weight vectors to which normalization has been applied) are used rather than extreme values of preceding layers.

To find the extreme values of results of a matrix multiplication (MatMul) operation, an input may be set such that the input vector is parallel to the longest basis of the weight matrix (e.g., column-vector with longest length). The length of the input vector used may be fixed due to normalization layers. The maximum length is at most \sqrt{n} before multiplication with the weight and may be specified as follows:

$$LayerNorm ( {a}_{i} ) = \frac{{a}_{i} - μ}{\sqrt{\frac{1}{n} {\sum }_{i = 1}^{n} {( {a}_{i} - μ )}^{2}}} {g}_{i} + {b}_{i} \qquad ( 8 )$$

$$RMSNorm ( {a}_{i} ) = \frac{{a}_{i}}{\sqrt{\frac{1}{n} {\sum }_{i = 1}^{n} {a}_{i}^{2}}} {g}_{i} \qquad ( 9 )$$

where aᵢ is the i-th dimension of the input vector, gᵢ is the i-th dimension of weight vector G of LayerNorm, and bᵢ is the i-th dimension of the bias of LayerNorm.

The maximum absolute value may be calculated by an analysis of the weights of a block of the ANN model. For example, the maximum absolute value may be calculated as follows:

$$\begin{matrix}Lin ( Rn ( \vec{x} ) ) & = & ( \frac{\vec{x}}{\sqrt{\frac{1}{n}} \vert \vec{x} \vert} ⊗ \vec{g} ) {A}^{T} & ( 10 ) \\ & = & \sqrt{n} \frac{\vec{x}}{\vert \vec{x} \vert} diag ( \vec{g} ) {A}^{T} & ( 11 ) \\ & = & \sqrt{n} \frac{\vec{x}}{\vert \vec{x} \vert} {GA}^{T} , & ( 12 )\end{matrix}$$

where Lin represents the linear operator, the length of vector

$$\frac{\vec{x}}{\vert \vec{x} \vert}$$

may be one due to normalization, A^{T} is the transpose of the attention matrix A, and Rn is the RMSNorm function defined in Equation 9. Then, the maximum absolute value with matrix multiplication of \sqrt{n}GA^{T} may be the longest basis of the matrix GA^{T}.

The elements of the result of a matrix multiplication will be the results of dot products of two vectors:

\vec{a}·\vec{b}=|\vec{a}|\vec{b}| cos θ, (13)

where the maximum absolute value of cos 0 is one. Then, the maximum result that may be produced may be the maximum values of |\vec{a}| and |\vec{b}|. As described, the maximum absolute value for |\vec{a}| is \sqrt{n}. Thus, the maximum absolute value in the result of the MatMul operation following an RMSNorm may be expressed as:

\sqrt{n}|\vec{m}|, (14)

where |\vec{m}′| is the length of the longest basis of matrix GA^{T}.

Having obtained the maximum absolute value, the scaling factor for the linear layer weight matrix may be determined as:

$$α = ceil ( \frac{maximum absolute value}{maximum representable number} ) , \qquad ( 15 )$$

where, ceil(x) is the ceiling function, which computes the smallest integer that is greater than or equal to x, the maximum absolute value may be derived as \sqrt{n}|\vec{m}′|, and the maximum representable number for IEEE FP16, for example, is 65504.

Accordingly, a different scaling factor may be determined for each block or layer of the ANN model. For example, when the ANN model comprises a transformer model, a same transformer decoder block may be repeated multiple times in the model. However, because the maximum value may differ for each of the transformer decoder blocks, the scaling factor for each such transformer decoder block may likewise differ for each transformer decoder block, unlike conventional approaches.

After the first linear layer following layer normalization, there may be further layers where an IEEE FP16 overflow may occur. For instance, for attention modules, the output may be expressed as:

z=Rn(x) (16)

attn_output=(softmax(zQ(zK)^{T})zV)O, (17)

where z is the normalized output from RMSNorm (z may, in some aspects, represent normalized out of a LayerNorm shown in Equation 8), K is a key projection matrix, Q is a query projection matrix, V is a value projection matrix, and O is the output projection matrix. The last output projection matrix O MatMul may not be combined with V MatMul because there is reshaping done for multi-headed attention. Additionally, the maximum value of zV may be calculated as described, for example, in Equations 10-14. To determine the maximum value (e.g., the maximum possible output) of softmax(zV), the maximum possible values of each column of zV may be determined. Each column of zV may have a maximum value as the norm of a corresponding column of the GA^{T} matrix multiplied by \sqrt{n}:

GA^{T}=[x₁ x₂ x₃ . . . ] (18)

max(xᵢ)=\sqrt{n}∥xᵢ∥₂. (19)

The values of softmax may have a maximum value of one. Then softmax( ) zV may produce the maximum possible row only when all columns of the projection weight matrix V are the same, which is highly unlikely, but possible in the worst case:

$$( soft max ( ) zV ) = [ \begin{matrix}0 & 1 & … & 0 \\ 0 & 0 & … & 1 \\ … & & & \\ 1 & 0 & … & 0\end{matrix} ] [ \begin{matrix}{x}_{11} & {x}_{12} & … & \text{?} \\ {x}_{max 1} & {x}_{max 2} & … & \text{?} \\ … & & & \\ \text{?} & \text{?} & … & \text{?}\end{matrix} ] . \qquad ( 20 )$$

$$\text{?} \text{indicates text missing or illegible when filed}$$

In the above example, the first row of the result of softmax( ) zV may be the maximum values. With this row, the maximum value of the result of (softmax( ) zV)O) may be determined using the norm of this vector with the maximum norm of the output weight matrix O:

[xₘₐₓ₁ xₘₐₓ₂ xₘₐₓ₃ . . . ]O. (21)

Again, the maximum values may be determined as:

max=length of xₘₐₓ*longest basis of O (e.g., the longest column of O) (22)

max=∥xₘₐₓ∥max(norm(O,dim=1)).

Then, the maximum value may be used to determine the scaling factor for the output project matrix multiplication, as described in Equation 15.

According, by applying the described techniques for selectively scaling blocks or layers of the ANN model, the ANN model may be converted, for instance from bfloat16 to IEEE FP16, without retraining the model. Thus, in various aspects, the ANN model may operate using hardware (e.g., a hardware accelerator) that supports IEEE FP16 rather than bfloat16, for example.

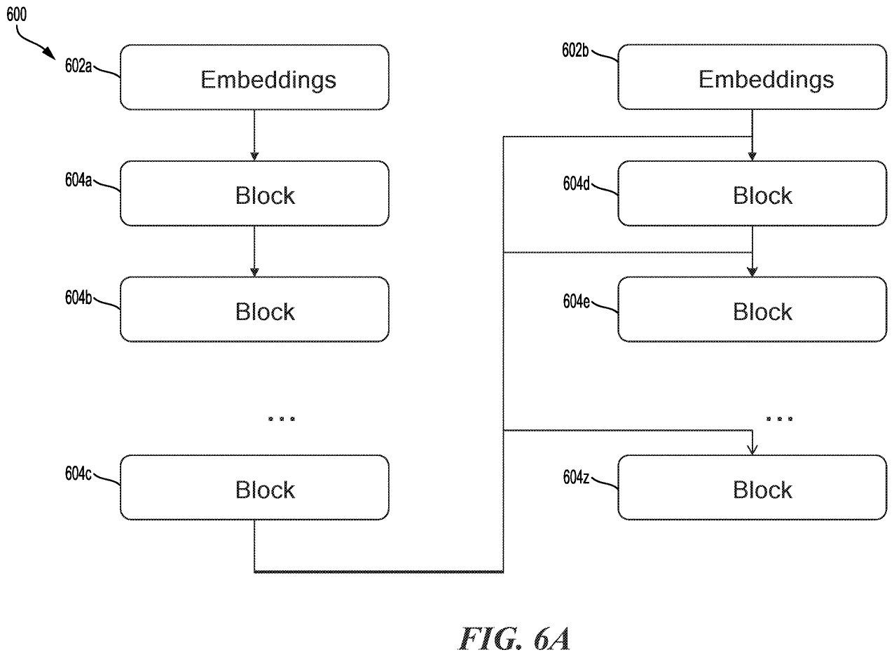

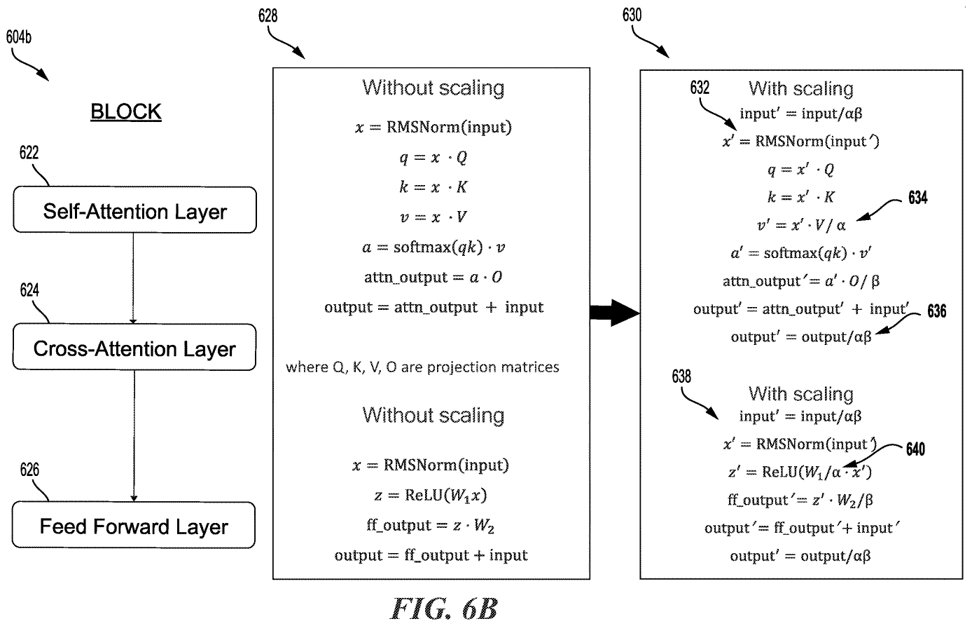

FIGS. 6A and 6B are block diagrams illustrating an example ANN model 600 and a corresponding conversion from bfloat16 to IEEE FP16 using a scaling factor, in accordance with various aspects of the present disclosure. Referring to FIG. 6A, the example ANN model 600 may be received as an input. The example ANN model 600 may, as shown in the non-limiting example of FIG. 6A, comprise a transformer neural network. The transformer neural network may comprise transformer architectures, such as (but not limited to) bi-directional encoder representations from transformers (BERT), the robustly optimized BERT approach (ROBERTa), XLNet, Transformer-XL, and the generative pre-trained transformer (GPT) family of transformers (e.g., GPT-2), for instance.

The example ANN model 600 may include multiple blocks 604a-z (collectively blocks 604). Each of the blocks (e.g., 604a-z) may comprise a self-attention layer and a feed-forward layer. In some aspects, the blocks (e.g., 604a-z) may also include a cross-attention block.

The ANN model 600 may be trained to operate on values in the bfloat16 format. That is, the weights of the blocks (e.g., 604a-z) may be pre-trained for operation on a received embedding (e.g., 602a and 602b), in accordance with the bfloat16 format.

Referring to FIG. 6B, an example block (e.g., 604b) is shown. The example block (e.g., 604b) includes a self-attention layer 622, a cross-attention layer 624, and a feed-forward layer 626. A set of example operations performed in each block (e.g., 604a-z) of the received ANN model 600, pre-trained according to IEEE FP16 format (e.g., without scaling), is provided in block 628.

As shown in block 630, a scaling factor a may be applied to selected blocks (e.g., 604b) or layers (e.g., 622) of the ANN model 600 according to the type of layer, for example. The value of the scaling factor a, however, may be determined based on the topology and distribution of weights in the respective layer as described, for instance, in Equations 1-22. For instance, in contrast to block 628, in block 630, an ANN (e.g., 600) includes an RMS normalization layer (632). As shown at 634, a scaling factor a is applied to the value projection weights. The scaling may be propagated through the network such that the output is also scaled (636). In another example, at 638, the ANN (e.g., 600) may include a dense layer with a ReLU activation. In this example, the ReLU does not have a bias term. Thus, the scaling parameter a may be applied at 640, in which weights W₁ may be scaled by the scaling factor a, as specified in Equations 1 and 2. If, however, the dense layer included a bias, the scaling factor may be applied to scale the weights (e.g., W₁) as well as the bias, as specified in Equation 3. Accordingly, a different scaling factor may be applied to different layers (e.g., 622) of the ANN model 600.

In some aspects, a different scaling parameter may be applied to layers having the same type. Because the scaling parameter may be based on the distribution of weights of the layer and the distribution of weights for even layers of the same type may differ, a different value of scaling parameter may be determined for each of such layers.

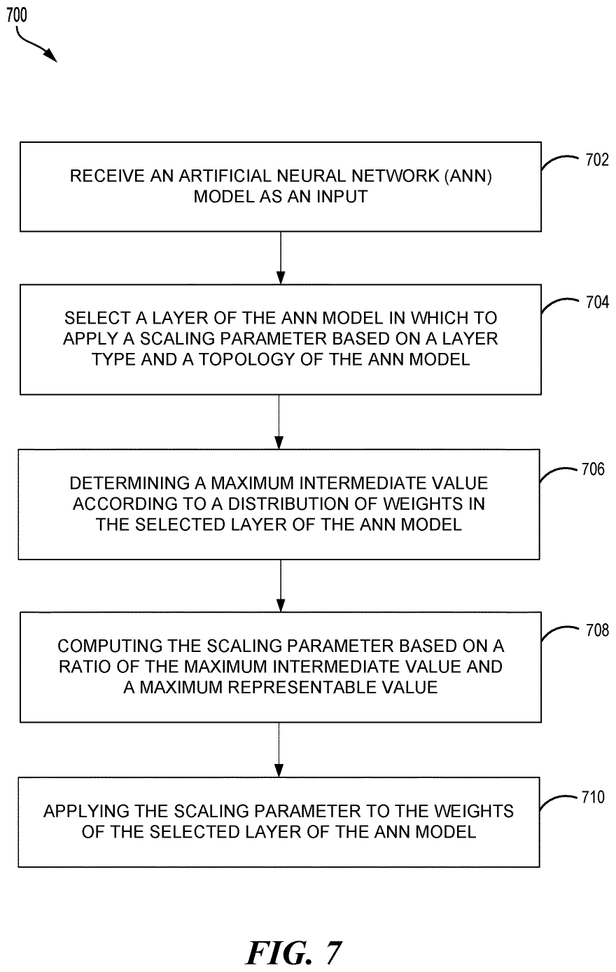

FIG. 7 is a flow diagram illustrating an example processor-implemented method 700 for converting pre-trained models from bfloat16 to IEEE FP16 using a varying scaling factor, in accordance with various aspects of the present disclosure. The processor-implemented method 700 may be performed by one or more processors such as the CPU 102, GPU 104, and/or NPU 108, for example.

As shown in FIG. 7, at block 702, the at least one processor receives an artificial neural network (ANN) model as an input. The ANN model is trained to operate on values in a sixteen-bit brain floating point (bfloat16) format. For example, as shown in FIG. 6A, an example ANN model 600 may be received as an input. The example ANN model 600 may comprise a transformer neural network, for instance. The transformer neural network may comprise a stable diffusion model such as the SDXL model or transformer architectures such as bi-directional encoder representations from transformers (BERT), the robustly optimized BERT approach (ROBERTa), XLNet, Transformer-XL, and the generative pre-trained transformer (GPT) family of transformers (e.g., GPT-2), for instance.

At block 704, the at least one processor selects a layer of the ANN model in which to apply a scaling parameter based on a layer type and a topology of the ANN model. For example, as shown in FIG. 6B, a layer of a block (e.g., 604b) may be selected for applying a scaling factor based on the layer type and the topology. In one example, a scaling factor may be applied to the self-attention layer 622 in accordance with block 630. For example, where the layer comprises an RMS normalization layer (e.g., 632), weight scaling may be applied.

At block 706, the at least one processor determines a maximum intermediate value according to a distribution of weights in the selected layer of the ANN model. As described with reference to FIG. 5, the intermediate values v may be given by matrix multiplication of the layer norm weights G and the transpose of the value projection weights V (GV^{T}) multiplied by the square root of the input dimensions (\sqrt{n}). At line 504, a maximum of the intermediate values (vₘₐₓ) may be determined. At line 506, a maximum output value (oₘₐₓ) may then be determined. The maximum output value (oₘₐₓ) may calculated by multiplying intermediate value v by the transpose of the maximum of the output projection weights O.

At block 708, the at least one processor computes the scaling parameter based on a ratio of a maximum intermediate value and the maximum representable value. For instance, as defined in Equation 15, the scaling factor a may be determined as the ceiling of the ratio of the maximum intermediate value for a layer of the ANN derived as \sqrt{n}|\vec{m}|, and the maximum representable number.

At block 710, the at least one processor applies the scaling parameter to weights of the selected layer of the ANN model. For instance, as described with reference to FIG. 6B, at 634, a scaling factor a may be applied to an RMS normalization layer. For instance, the value projection weights may be divided by the scaling factor α. In turn, the weight scaling may be propagated through the network such that the output is also scaled (e.g., 636) as a result of the scaling at 634. Additionally, as described, for a dense layer (e.g., fully connected layer) with a rectifier linear unit (ReLU) activation or without any activation, a scaling factor α may be applied to the weights as specified in Equation 1, if the dense layer does not have a bias. On the other hand, if the dense layer does have a bias, the scaling factor α may be applied to the weight and the bias as specified in Equation 3.

Implementation examples are provided in the following numbered clauses.
1. An apparatus comprising:
   at least one memory; and
   at least one processor coupled to the at least one memory, the at least one processor configured to:
      receive an artificial neural network (ANN) model as an input, the ANN model being trained to operate on values in a first floating point format having a bit length;
      selecting a layer of the ANN model in which to apply a scaling parameter based on a layer type and a topology of the ANN model;
      determining a maximum intermediate value according to a distribution of weights in the selected layer of the ANN model;
      computing the scaling parameter based on a ratio of the maximum intermediate value and a maximum representable value; and
      applying the scaling parameter to weights of the selected layer of the ANN model.
2. The apparatus of clause 1, in which the first floating point format is a sixteen-bit brain floating point (bfloat16) format.
3. The apparatus of clause 1 or 2, in which the at least one processor is further configured to apply the scaling parameter to a dense layer regardless of whether a bias value for the dense layer is zero or non-zero.
4. The apparatus of any of clauses 1-3, in which the at least one processor is further configured to apply a scaling operator between layers of the ANN model, the scaling operator conducting an elementwise multiplication of the scaling parameter and an activation output from a preceding layer.
5. The apparatus of any of clauses 1-4, in which the at least one processor is further configured to apply the scaling parameter to a layer having a non-linear activation function that precedes a linear layer or a convolutional layer.
6. The apparatus of any of clauses 1-5, in which the at least one processor is further configured to inversely apply the scaling parameter of a preceding layer to a normalization layer to the normalization layer.
7. The apparatus of any of clauses 1-6, in which the at least one processor is further configured to determine the maximum intermediate value based on a longest basis of a matrix multiplication of a set of layer norm weights and a set of intermediate activations.
8. A processor-implemented method performed by at least one processor, the processor-implemented method comprising:
   receiving an artificial neural network (ANN) model as an input, the ANN model being trained to operate on values in a first floating point format having a bit length;
   selecting a layer of the ANN model in which to apply a scaling parameter based on a layer type and a topology of the ANN model;
   determining a maximum intermediate value according to a distribution of weights in the selected layer of the ANN model;
   computing the scaling parameter based on a ratio of the maximum intermediate value and a maximum representable value; and
   applying the scaling parameter to weights of the selected layer of the ANN model.
9. The processor-implemented method of clause 8, in which the first floating point format is a sixteen-bit brain floating point (bfloat16) format.
10. The processor-implemented method of clause 8 or 9, in which the scaling parameter is applied to a dense layer regardless of whether a bias value for the dense layer is zero or non-zero.
11. The processor-implemented method of any of clauses 8-10, further comprising applying a scaling operator between layers of the ANN model, the scaling operator conducting an elementwise multiplication of the scaling parameter and an activation output from a preceding layer.
12. The processor-implemented method of any of clauses 8-11, in which the scaling parameter is applied to a layer having a non-linear activation function that precedes a linear layer or a convolutional layer.
13. The processor-implemented method of any of clauses 8-12, in which the scaling parameter of a preceding layer to a normalization layer is inversely applied to the normalization layer.
14. The processor-implemented method of any of clauses 8-13, in which the maximum intermediate value is determined based on a longest basis of a matrix multiplication of a set of layer norm weights and a set of intermediate activations.
15. A non-transitory computer-readable medium having program code recorded thereon, the program code executed by a processor and comprising:
   program code to receive an artificial neural network (ANN) model as an input, the ANN model being trained to operate on values in a first floating point format having a bit length;
   program code to select a layer of the ANN model in which to apply a scaling parameter based on a layer type and a topology of the ANN model;
   program code to determine a maximum intermediate value according to a distribution of weights in the selected layer of the ANN model;
   program code to compute the scaling parameter based on a ratio of the maximum intermediate value and a maximum representable value; and
   program code to apply the scaling parameter to weights of the selected layer of the ANN model.
16. The non-transitory computer-readable medium of clause 15, in which the first floating point format is a sixteen-bit brain floating point (bfloat16)format.
17. The non-transitory computer-readable medium of clause 15 or 16, in which the program code comprises program code to apply the scaling parameter to a dense layer regardless of whether a bias value for the dense layer is zero or non-zero.
18. The non-transitory computer-readable medium of any of clauses 15-17, in which the program code comprises program code to apply a scaling operator between layers of the ANN model, the scaling operator conducting an elementwise multiplication of the scaling parameter and an activation output from a preceding layer.
19. The non-transitory computer-readable medium of any of clauses 15-18, in which the scaling parameter is applied to a layer having a non-linear activation function that precedes a linear layer or a convolutional layer.
20. The non-transitory computer-readable medium of any of clauses 15-19, in which the program code comprises program code to inversely apply the scaling parameter of a preceding layer to a normalization layer to the normalization layer.
21. The non-transitory computer-readable medium of any of clauses 15-20, in which the program code comprises program code to determine the maximum intermediate value based on a longest basis of a matrix multiplication of a set of layer norm weights and a set of intermediate activations.
22. An apparatus, comprising:
   means for receiving an artificial neural network (ANN) model as an input, the ANN model being trained to operate on values in a first floating point format having a bit length;
   means for selecting a layer of the ANN model in which to apply a scaling parameter based on a layer type and a topology of the ANN model;
   means for determining a maximum intermediate value according to a distribution of weights in the selected layer of the ANN model;
   means for computing the scaling parameter based on a ratio of the maximum intermediate value and a maximum representable value; and
   means for applying the scaling parameter to weights of the selected layer of the ANN model.
23. The apparatus of clause 22, in which the first floating point format is a sixteen-bit brain floating point (bfloat16) format.
24. The apparatus of clause 22 or 23, further comprising means for applying the scaling parameter to a dense layer regardless of whether a bias value for the dense layer is zero or non-zero.
25. The apparatus of any of clauses 22-24, further comprising means for applying a scaling operator between layers of the ANN model, the scaling operator conducting an elementwise multiplication of the scaling parameter and an activation output from a preceding layer.
26. The apparatus of any of clauses 22-25, in which the scaling parameter is applied to a layer having a non-linear activation function that precedes a linear layer or a convolutional layer.
27. The apparatus of any of clauses 22-26, further comprising means for inversely applying the scaling parameter of a preceding layer to a normalization layer to the normalization layer.
28. The apparatus of any of clauses 22-27, further comprising means for determining the maximum intermediate value based on a longest basis of a matrix multiplication of a set of layer norm weights and a set of intermediate activations.

In one aspect, the receiving means, selecting means, and/or applying means may be the CPU 102 GPU 104, program memory associated with the CPU 102 or GPU 104, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus comprising:
at least one memory; and
at least one processor coupled to the at least one memory, the at least one processor configured to:
receive an artificial neural network (ANN) model as an input, the ANN model being trained to operate on values in a first floating point format having a bit length;
select a layer of the ANN model in which to apply a scaling parameter based on a layer type and a topology of the ANN model;
determine a maximum intermediate value according to a distribution of weights in the selected layer of the ANN model;
compute the scaling parameter based on a ratio of the maximum intermediate value and a maximum representable value; and
apply the scaling parameter to weights of the selected layer of the ANN model.

2. The apparatus of claim 1, in which the first floating point format is a sixteen-bit brain floating point (bfloat16) format.

3. The apparatus of claim 1, in which the at least one processor is further configured to apply the scaling parameter to a dense layer regardless of whether a bias value for the dense layer is zero or non-zero.

4. The apparatus of claim 1, in which the at least one processor is further configured to apply a scaling operator between layers of the ANN model, the scaling operator conducting an elementwise multiplication of the scaling parameter and an activation output from a preceding layer.

5. The apparatus of claim 1, in which the at least one processor is further configured to apply the scaling parameter to a layer having a non-linear activation function that precedes a linear layer or a convolutional layer.

6. The apparatus of claim 1, in which the at least one processor is further configured to inversely apply the scaling parameter of a preceding layer to a normalization layer to the normalization layer.

7. The apparatus of claim 1, in which the at least one processor is further configured to determine the maximum intermediate value based on a longest basis of a matrix multiplication of a set of layer norm weights and a set of intermediate activations.

8. A processor-implemented method performed by at least one processor, the processor-implemented method comprising:
receiving an artificial neural network (ANN) model as an input, the ANN model being trained to operate on values in a first floating point format having a bit length;
selecting a layer of the ANN model in which to apply a scaling parameter based on a layer type and a topology of the ANN model;
determining a maximum intermediate value according to a distribution of weights in the selected layer of the ANN model;
computing the scaling parameter based on a ratio of the maximum intermediate value and a maximum representable value; and
applying the scaling parameter to weights of the selected layer of the ANN model.

9. The processor-implemented method of claim 8, in which the first floating point format is a sixteen-bit brain floating point (bfloat16) format.

10. The processor-implemented method of claim 8, in which the scaling parameter is applied to a dense layer regardless of whether a bias value for the dense layer is zero or non-zero.

11. The processor-implemented method of claim 8, further comprising applying a scaling operator between layers of the ANN model, the scaling operator conducting an elementwise multiplication of the scaling parameter and an activation output from a preceding layer.

12. The processor-implemented method of claim 8, in which the scaling parameter is applied to a layer having a non-linear activation function that precedes a linear layer or a convolutional layer.

13. The processor-implemented method of claim 8, in which the scaling parameter of a preceding layer to a normalization layer is inversely applied to the normalization layer.

14. The processor-implemented method of claim 8, in which the maximum intermediate value is determined based on a longest basis of a matrix multiplication of a set of layer norm weights and a set of intermediate activations.

15. An apparatus, comprising:
means for receiving an artificial neural network (ANN) model as an input, the ANN model being trained to operate on values in a first floating point format having a bit length;
means for selecting a layer of the ANN model in which to apply a scaling parameter based on a layer type and a topology of the ANN model;
means for determining a maximum intermediate value according to a distribution of weights in the selected layer of the ANN model;
means for computing the scaling parameter based on a ratio of the maximum intermediate value and a maximum representable value; and
means for applying the scaling parameter to weights of the selected layer of the ANN model.

16. The apparatus of claim 15, in which the first floating point format is a sixteen-bit brain floating point (bfloat16) format.

17. The apparatus of claim 15, further comprising means for applying the scaling parameter to a dense layer regardless of whether a bias value for the dense layer is zero or non-zero.

18. The apparatus of claim 15, further comprising means for applying a scaling operator between layers of the ANN model, the scaling operator conducting an elementwise multiplication of the scaling parameter and an activation output from a preceding layer.

19. The apparatus of claim 15, in which the scaling parameter is applied to a layer having a non-linear activation function that precedes a linear layer or a convolutional layer.

20. The apparatus of claim 15, further comprising means for inversely applying the scaling parameter of a preceding layer to a normalization layer to the normalization layer.
